(19) United States
(12) Patent Application Publication
(10) Pub. No.: US 2020/0141651 A1
(43) Pub. Date: May 7, 2020

(54) Ceramic production and purification equipment

(71) Applicant: Jili Ye, Tianjin City (CN)

(72) Inventor: Jili Ye, Tianjin City (CN)

(21) Appl. No.: 16/736,788

(22) Filed: Jan. 7, 2020

(30) Foreign Application Priority Data
Oct. 11, 2019 (CN) 2019109638576

(51) Int. Cl. F27D 3/00; C04B 35/626; F27B 5/02; F27D 5/00; F27B 17/00

(52) U.S. Cl. CPC F27D 3/0022; C04B 35/62645; F27B 17/0041; F27D 5/0031; F27B 5/02

(57) ABSTRACT

The ceramic production and purification equipment of the present invention comprises a first fuselage, a furnace is fixedly arranged on the right end surface of the first fuselage, a cavity is provided in the first fuselage, and a top surface of the first fuselage is provided. A fixed block is fixedly fixed, and a feeding slot with an upward opening is provided in the fixed block. The device of the present invention can purify the ceramic before melting and casting. Compared with the traditional purification equipment, the device can remove iron impurities more thoroughly and the produced ceramics have higher purity. The equipment can also remove other impurities, while the operation is simple and clear, convenient and fast. In addition, the equipment can screen fine ceramic powder for melting, reducing the time required for melting ceramic powder, and the equipment has high purification efficiency.

### CROSS-REFERENCES TO RELATED APPLICATIONS

The present application claims priority from Chinese application No. 2019103101581 filed on Apr. 17, 2019 which is hereby incorporated by reference in its entirety.

### TECHNICAL FIELD

The invention relates to the field of ceramics production, in particular to a ceramics production and purification equipment.

### BACKGROUND OF THE INVENTION

As we all know, ceramic is an inorganic non-metallic material, which can be used as a structural material, a cutter material or a functional material. In the production process of ceramic products, some impurities will inevitably be included. Among them, iron impurities will affect the whiteness of the product and affect the whiteness of the product. The electrical properties of ceramics; in order to improve the production yield of ceramic products, ceramics need to be purified; traditional ceramic purification equipment has a single function, low purification efficiency, and not thorough enough; therefore, a ceramic production and purification equipment needs to be designed to solve the above problems.

### BRIEF SUMMARY OF THE INVENTION

The technical problem to be solved by the present invention is to provide a ceramic production and purification equipment, which can purify ceramics before the ceramics are melt-casted, and at the same time the equipment is safe and reliable, and the operation is simple and clear.

The present invention is achieved by the following technical solutions.

The ceramic production and purification equipment of the present invention includes a first fuselage, and a furnace is fixedly arranged on the right end face of the first fuselage;

A cavity is provided in the first body, and a fixing block is fixed on the top surface of the first body. The fixing block is provided with a feeding slot with an upward opening. Powder, a powder screening mechanism for screening finer ceramic powder into the cavity is provided between the cavity and the feeding tank;

A first transmission cavity is provided in the bottom wall of the cavity, and a first rotation shaft is rotatably provided between the first transmission cavity and the cavity. A circle is fixed on the first rotation shaft in the cavity The top surface of the disc is provided with magnet rods symmetrically fixed on the left and right sides of the disc. A material transport slot is provided between the cavity and the furnace. Iron impurity removing mechanism for magnet rod to adsorb iron impurities in ceramic powder;

A second fuselage is provided on the right side of the first fuselage, and a heat preservation cavity is provided in the second fuselage. A pipe is connected between the heat preservation cavity and the furnace, and a clearing is provided in the heat preservation cavity. Refractory impurity removing mechanism for refractory impurities in ceramic solution.

Further, the powder screening mechanism includes the feeding slot, and a first sliding cavity is provided between the feeding slot and the cavity, and the first sliding cavity is slidably provided to block the first sliding cavity. A first slider of a sliding cavity is provided with first through holes penetrating up and down symmetrically in the first slider.

Further, a second sliding cavity is provided on the left end wall of the first sliding cavity in the first body, and a second sliding cavity is slidably provided in the second sliding cavity. A slide plate, a first spring is connected between the first slide plate and the bottom wall of the second slide cavity.

Further, a second transmission cavity is provided in the left end wall of the second sliding cavity, and a second rotating shaft is provided between the second transmission cavity and the second sliding cavity for rotation, and the second sliding cavity is A cam that abuts the bottom surface of the first sliding plate is fixed on the second rotating shaft, and a first pulley is fixed on the second rotating shaft in the second transmission cavity.

Further, the iron impurity removing mechanism includes the first transmission cavity, a motor is fixedly located on the right end wall of the first transmission cavity, and a left end of the motor is power-connected to extend into the second transmission cavity. A driving shaft, a second pulley is fixed on the driving shaft in the second transmission cavity, and a first belt is drivingly connected between the second pulley and the first pulley.

Further, a first bevel gear is fixed on the driving shaft in the first transmission cavity, and a first bevel gear meshing with the first bevel gear is fixed on the first rotating shaft in the first transmission cavity. The second bevel gear.

Further, a third transmission cavity is provided in an end wall between the second transmission cavity and the first transmission cavity, and a third pulley is fixed on the driving shaft in the third transmission cavity. A third rotation shaft is provided between the third transmission cavity and the cavity, and a fourth pulley is fixed on the third rotation shaft in the third transmission cavity. The fourth pulley and the third A second belt is drivingly connected between the pulleys. A spiral feeder is fixed on the cavity and the third rotating shaft in the material conveying trough. A connecting rod is fixed on the top wall of the material conveying trough. The bottom surface of the connecting rod is fixedly provided with a cylinder that is in contact with the outer surface of the third rotation shaft, and a relative rotation can be generated between the cylinder and the third rotation shaft.

Further, the refractory impurity removing mechanism includes the heat-retaining cavity, the bottom wall of the heat-retaining cavity is an arc surface recessed downward, and the bottom wall of the heat-retaining cavity is fixed with a permanent magnet.

Further, the right end wall of the heat preservation cavity located above the arc surface of the heat preservation cavity is provided with a first slide groove penetrating left and right, a second slide plate is slidably arranged in the first slide groove, and a second slide plate is provided in the second slide plate. A second through hole with an opening to the right and an upward opening. In the initial state, the second through hole is not connected to the heat preservation cavity, and a second chute is connected to the bottom wall of the first chute, and the second A second slider fixed to the second slide is slidably provided in the chute, and a second spring is connected between the second slider and the left end wall of the second chute.

Beneficial effects of the present invention: The equipment of the present invention can purify ceramics before melting and casting. Compared with traditional purification equipment, the equipment can remove iron impurities more thoroughly and the produced ceramics have higher purity; the equipment can also remove other impurities. At the same time, the operation is simple and clear, convenient and fast; in addition, the equipment can screen fine ceramic powders for melting, reducing the time required for melting ceramic powders, and the equipment has high purification efficiency.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic diagram of a mechanical structure according to an embodiment of the present invention;

FIG. 2 is an enlarged structural diagram of B in FIG. 1;

FIG. 3 is a schematic structural diagram of A-A in FIG. 1.

### DETAILED DESCRIPTION OF THE INVENTION

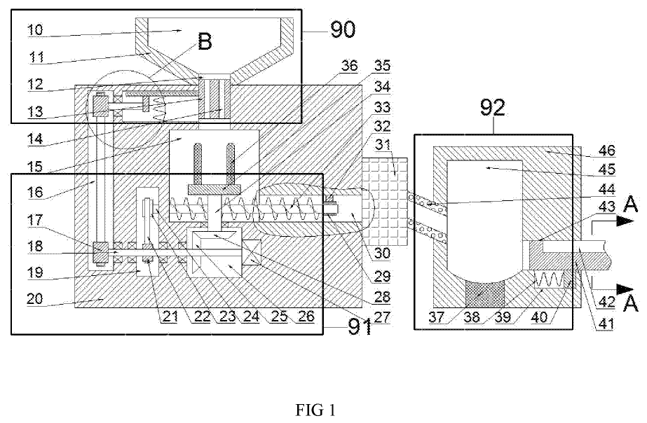

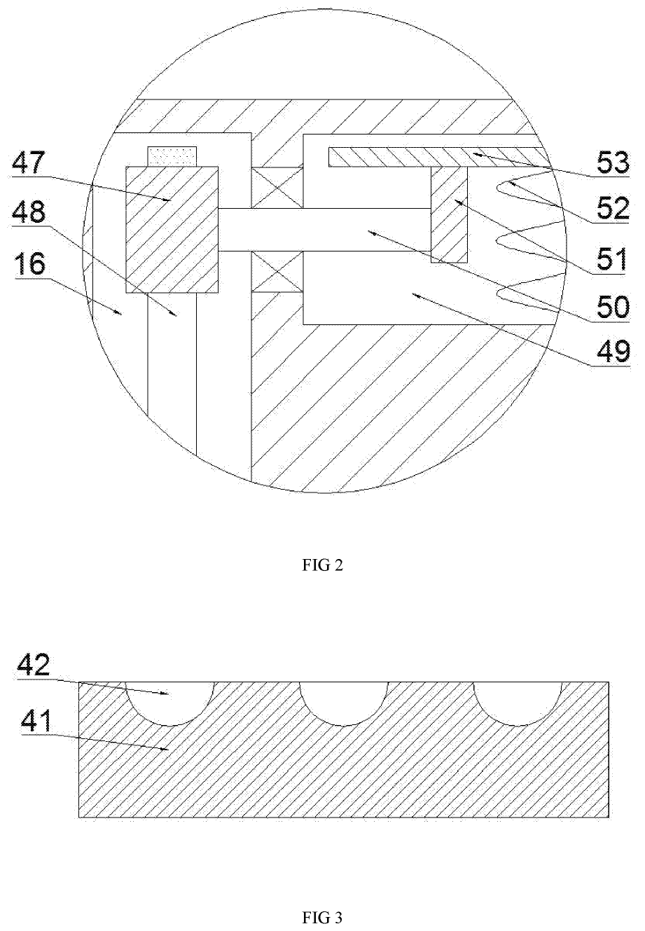

The present invention is described in detail below with reference to FIGS. 1-3. For convenience of description, the orientation described below is defined as follows: the up-down, left-right, front-back direction described below is consistent with the up-down, left-right, front-back direction of the projection relationship of FIG. 1 itself.

A ceramic production and purification equipment as described with reference to FIGS. 1-3 includes a first fuselage 20, and a furnace 31 is fixed on the right end face of the first fuselage 20;

The first body 20 is provided with a cavity 15 therein. The top surface of the first body 20 is fixedly provided with a fixing block 11. The fixing block 11 is provided with a feeding slot 10 with an opening upward. Ceramic powder may be added in the tank 10, and a powder screening mechanism 90 for screening finer ceramic powder into the cavity 15 is provided between the cavity 15 and the feeding tank 10;

A first transmission cavity 26 is provided in the bottom wall of the cavity 15, and a first rotating shaft 34 is provided between the first transmission cavity 26 and the cavity 15 for rotation. A disk 35 is fixed on the rotating shaft 34. The top surface of the disk 35 is provided with magnet rods 36 symmetrically fixed on the left and right sides. A material transport slot 30 is provided between the cavity 15 and the furnace 31. The cavity An iron impurity removing mechanism 91 for adsorbing iron impurities in ceramic powder by using the magnet rod 36 is provided between 15 and the material transport tank 30;

A second fuselage 46 is provided on the right side of the first fuselage 20, and a heat preservation cavity 45 is provided in the second fuselage 46. A pipe 44 is provided between the heat preservation cavity 45 and the furnace 31. The heat preservation cavity 45 is provided with a refractory impurity removing mechanism 92 for removing refractory impurities in the ceramic solution.

The powder screening mechanism 90 includes the feeding tank 10, and a first sliding chamber 12 is provided between the feeding tank 10 and the cavity 15. A sliding block 12 is slidably provided in the first sliding chamber 12. The first slider 13 of the first sliding cavity 12 is provided with first through holes 14 penetrating up and down symmetrically inside the first slider 13.

A second sliding cavity 49 is connected to the left end wall of the first sliding cavity 12 in the first body 20, and the second sliding cavity 49 is slidably fixed to the first slider 13. The first slide plate 53 is connected with a first spring 52 between the first slide plate 53 and the bottom wall of the second slide cavity 49.

A second transmission cavity 16 is provided in the left end wall of the second sliding cavity 49, and a second rotating shaft 50 is provided between the second transmission cavity 16 and the second sliding cavity 49 to rotate. A cam 51 abutting the bottom surface of the first slide plate 53 is fixed on the second rotating shaft 50 in the cavity 49, and a first pulley is fixed on the second rotating shaft 50 in the second transmission cavity 16. 47. When the first pulley 47 rotates, the first pulley 47 drives the cam 51 to rotate. After the cam 51 rotates, the first sliding plate 53 is continuously pressed. At this time, the first sliding plate 53 is at The pressing force of the cam 51 and the pulling force of the first spring 52 slide up and down, and the first slide plate 53 slides up and down to drive the first slider 13 to shake up and down. When the first slider 13 shakes up and down The ceramic powder in the feeding tank 10 can begin to flow, and at this time, the finer ceramic powder can pass through the first through hole 14 and enter the cavity 15.

The iron impurity removing mechanism 91 includes the first transmission cavity 26. A motor 27 is fixed on the right end wall of the first transmission cavity 26, and the left end of the motor 27 is connected to the second transmission cavity by power. A driving shaft 18 in 16 is provided. A second pulley 17 is fixed on the driving shaft 18 in the second transmission cavity 16. A first transmission is connected between the second pulley 17 and the first pulley 47. Belt 48.

A first bevel gear 25 is fixed on the driving shaft 18 in the first transmission cavity 26, and a first bevel gear is fixed on the first rotating shaft 34 in the first transmission cavity 26. 25 meshing second bevel gear 28.

A third transmission cavity 19 is provided in an end wall between the second transmission cavity 16 and the first transmission cavity 26, and a third pulley is fixed on the driving shaft 18 in the third transmission cavity 19 21, a third rotation shaft 24 is provided between the third transmission cavity 19 and the cavity 15, and a fourth pulley 23 is fixed on the third rotation shaft 24 in the third transmission cavity 19, so A second belt 22 is drivingly connected between the fourth pulley 23 and the third pulley 21, and a screw feeder is fixed on the cavity 15 and the third rotating shaft 24 in the material conveying groove 30. 33. A connecting rod 32 is fixedly arranged on the top wall of the hopper 30, and a cylinder 29 in contact with the outer surface of the third rotating shaft 24 is fixedly arranged on the bottom surface of the connecting rod 32. Relative rotation can occur between the three rotating shafts 24. When the motor 27 is activated, the motor 27 drives the second pulley 17, the third pulley 21, and the first bevel gear 25 to rotate. After the two pulleys 17 rotate, the second pulley 17 drives the first pulley 47 through the first belt 48, and at the same time, the first cone The gear 25 drives the second bevel gear 28 to rotate. The second bevel gear 28 drives the disc 35 to rotate. The disc 35 drives the magnet rod 36 to rotate about the center of the first rotation shaft 34. The magnet rod 36 is in contact with the ceramic powder falling downward under the action of gravity. The magnet rod 36 can adsorb iron impurities in the ceramic powder. In addition, the third pulley 21 is driven by the second belt 22 The fourth pulley 23 rotates, and the fourth pulley 23 drives the screw feeder 33 to rotate. When the screw feeder 33 rotates, the screw feeder 33 causes the screw feeder 33 to fall in the cavity 15. The ceramic powder on the bottom wall is transported to the right. At this time, the ceramic powder is transported to the right through the feed tank 30 into the melting furnace 31 and heated to a ceramic melt.

The refractory impurity removing mechanism 92 includes the heat-retaining cavity 45, the bottom wall of which is a downwardly concave arc surface, and a permanent magnet 37 is fixed on the bottom wall of the heat-retaining cavity 45.

The right end wall of the insulation cavity 45 located above the arc surface of the insulation cavity 45 is provided with a first sliding slot 43 penetrating left and right, and a second sliding plate 41 is slidably arranged in the first sliding slot 43. The second sliding plate 41 Inside, a second through hole 42 with an opening to the right and an upward opening is provided. In the initial state, the second through hole 42 does not communicate with the heat preservation cavity 45, and a bottom wall of the first sliding groove 43 is provided with a second communicating hole. A chute 39 is provided with a second slider 40 fixed to the second slide plate 41 in the second chute 39, and the second slider 40 is connected to the left end wall of the second chute 39 There is a second spring 38. After the ceramic powder is melted in the furnace 31 to form a ceramic melt, the ceramic melt can flow into the heat preservation cavity 45 through the pipe 44. At this time, the permanent magnet 37 can adsorb ceramic Iron impurities in the melt that have not been removed by the iron impurity removing mechanism 91, and impurities that are difficult to melt in the ceramic powder will also be deposited on the arc surface of the insulation cavity 45, and then the user will The two sliding plates 41 are pushed to the left into the insulation cavity 45. At this time, the second sliding plate 41 drives the second through hole 42 to slide to the left. The second through hole 42 slides to the left and communicates with the insulation cavity 45. The ceramic melt in the insulation cavity 45 flows to the right through the second through hole 42. Difficult impurities still remain in the heat-preserving cavity 45, and the ceramic melt that passes through the second through hole 42 can be melt-casted to produce various ceramic products.

The sequence of mechanical actions of the entire equipment:

1: First, the user adds ceramic powder to the feeding tank 10, and then the user starts the motor 27;

2: After the motor 27 is started, the motor 27 drives the second pulley 17, the third pulley 21, and the first bevel gear 25 to rotate. When the second pulley 17 rotates, the The second pulley 17 drives the first pulley 47 to rotate through the first belt 48. When the first pulley 47 rotates, the first pulley 47 drives the cam 51 to rotate. Squeeze the first slide plate 53. At this time, the first slide plate 53 slides up and down under the pressing force of the cam 51 and the pulling force of the first spring 52, and the first slide plate 53 slides up and down to drive the The first slider 13 shakes up and down. When the first slider 13 shakes up and down, the ceramic powder in the feeding tank 10 can start to flow. At this time, the finer ceramic powder can pass through the first through hole 14. Into the cavity 15, the equipment can screen fine ceramic powders for melting, reducing the time required for melting ceramic powders, and the equipment has high purification efficiency;

3: At the same time, the first bevel gear 25 drives the second bevel gear 28 to rotate, the second bevel gear 28 drives the disc 35 to rotate, and the disc 35 drives the magnet rod 36 to rotate The first rotating shaft 34 rotates in the center, and the rotating magnet rod 36 is in contact with the ceramic powder falling downward under the action of gravity, and the magnet rod 36 can adsorb iron impurities in the ceramic powder;

4: In addition, the third pulley 21 drives the fourth pulley 23 to rotate through the second belt 22, and the fourth pulley 23 drives the spiral feeder 33 to rotate. After the rotation, the screw feeder 33 transports the ceramic powder falling on the bottom wall of the cavity 15 to the right. At this time, the ceramic powder is transported to the right through the feeding tank 30 into the furnace 31 and heated to Ceramic melt

5: After the ceramic powder is melted in the melting furnace 31 to form a ceramic melt, the ceramic melt can flow through the pipe 44 to the heat preservation cavity 45, and at this time, the permanent magnet 37 can adsorb the ceramic melt Compared with traditional purification equipment, the iron impurities removed by the iron impurity removing mechanism 91 are more thorough in removing iron impurities and the ceramics produced are more pure;

6: At the same time, impurities that are difficult to melt in the ceramic powder will also be deposited on the arc surface of the heat preservation cavity 45, and then the user pushes the second slide plate 41 to the left into the heat preservation cavity 45 by hand. The second sliding plate 41 drives the second through hole 42 to slide to the left, and the second through hole 42 slides to the left to communicate with the heat preservation cavity 45, and the ceramic melt in the heat preservation cavity 45 passes through the first Two through-holes 42 flow to the right, and difficult-to-contain impurities at the arc surface of the heat-preserving cavity 45 still remain in the heat-preserving cavity 45, and the ceramic melt that passes through the second through-hole 42 can be subjected to melt-casting production. With the production of various ceramic products, the equipment can also remove other impurities, while the operation is simple and clear, convenient and fast.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A ceramic production and purification equipment includes a first fuselage, characterized in that a furnace is fixedly arranged on the right end face of the first fuselage;
a cavity is provided in the first body, and a fixing block is fixed on the top surface of the first body. The fixing block is provided with a feeding slot with an upward opening. Powder, a powder screening mechanism for screening finer ceramic powder into the cavity is provided between the cavity and the feeding tank;
a first transmission cavity is provided in the bottom wall of the cavity, and a first rotation shaft is rotatably provided between the first transmission cavity and the cavity. A circle is fixed on the first rotation shaft in the cavity The top surface of the disc is provided with magnet rods symmetrically fixed on the left and right sides of the disc. A material transport slot is provided between the cavity and the furnace. Iron impurity removing mechanism for magnet rod to adsorb iron impurities in ceramic powder;
a second fuselage is provided on the right side of the first fuselage, and a heat preservation cavity is provided in the second fuselage. A pipe is connected between the heat preservation cavity and the furnace, and a clearing is provided in the heat preservation cavity. Refractory impurity removing mechanism for refractory impurities in ceramic solution.

2. The ceramic production and purification equipment according to claim 1, characterized in that: the powder screening mechanism includes the feeding tank, and a first sliding cavity is provided between the feeding tank and the cavity, A first slider capable of blocking the first sliding cavity is slidably provided in the first sliding cavity, and first through holes are symmetrically provided in the first slider.

3. The ceramic production and purification equipment according to claim 2, wherein a left side wall of the first sliding cavity in the first body is provided with a second sliding cavity, and the second sliding A first slide plate fixed to the first slider is slid in the cavity, and a first spring is connected between the first slide plate and a bottom wall of the second slide cavity.

4. The ceramic production and purification equipment according to claim 3, wherein a second transmission cavity is provided in a left end wall of the second sliding cavity, and the second transmission cavity and the second sliding cavity A second rotating shaft is provided between the two rotating shafts. A cam contacting the bottom surface of the first sliding plate is fixed on the second rotating shaft in the second sliding cavity. The second rotating shaft in the second transmission cavity A first pulley is fixed on the upper part.

5. The ceramic production and purification equipment according to claim 1, wherein the iron impurity removing mechanism includes the first transmission cavity, and a motor is fixed on the right end wall of the first transmission cavity. A driving shaft extending into the second transmission cavity is connected to the left end of the motor. A second pulley is fixed on the driving shaft in the second transmission cavity. A first belt is connected to the transmission.

6. The ceramic production and purification equipment according to claim 5, wherein a first bevel gear is fixed on the driving shaft in the first transmission cavity, and the first A second bevel gear meshing with the first bevel gear is fixed on a rotating shaft.

7. The ceramic production and purification equipment according to claim 6, wherein a third transmission cavity is provided in an end wall between the second transmission cavity and the first transmission cavity, and the third transmission cavity A third pulley is fixed on the driving shaft inside, a third rotating shaft is rotated between the third driving cavity and the cavity, and the third rotating shaft in the third driving cavity is fixed on There is a fourth pulley, a second belt is drivingly connected between the fourth pulley and the third pulley, and a spiral feeder is fixed on the cavity and the third rotating shaft in the material transport slot. A rod is fixed on the top wall of the hopper, and a cylinder in contact with the outer surface of the third rotating shaft is fixed on the bottom surface of the connecting rod. The cylinder and the third rotating shaft can be opposed to each other. Turn.

8. The ceramic production and purification equipment according to claim 1, wherein the refractory impurity removing mechanism comprises the heat preservation cavity, a bottom wall of the heat preservation cavity is an arc surface recessed downward, and the bottom of the heat preservation cavity The wall is fixed with a permanent magnet.

9. The ceramic production and purification equipment according to claim 8, characterized in that the right end wall of the heat preservation cavity located above the arc surface of the heat preservation cavity is provided with left and right first chute through which the first chute is arranged. A second sliding plate is provided for sliding, and a second through hole with an opening to the right and an upward opening is provided in the second sliding plate. In the initial state, the second through hole does not communicate with the heat preservation cavity. A second slide groove is communicated with the bottom wall of the groove, and a second slider fixed to the second slide plate is slidably arranged in the second slide groove, and the second slider and the left end wall of the second slide groove A second spring is connected in between.
